(19) United States
(12) Patent Application Publication
(10) Pub. No.: US 2007/0255680 A1
(43) Pub. Date: Nov. 1, 2007

(54) Logical dispensability indicator

(76) Inventor: Kenneth C. Baran, Hebron, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/411,302

(22) Filed: Apr. 26, 2006

(51) Int. Cl. G06F 17/30

(52) U.S. Cl. 707/2

(57) ABSTRACT

A method of searching a database utilizing a dispensability indicator includes entering a logical expression into a search engine, indicating the dispensability of a portion of the logical expression to define a primary search strategy and a secondary search strategy, and returning search results that include records satisfying the primary search strategy. The dispensability of each portion of the logical expression is indicated by embracing at least a portion of the logical expression with the dispensability indicator. A search result with records that satisfy the requirements of the secondary search strategy is automatically returned in response to a failure to return records satisfying the requirements of the primary search strategy.

### BACKGROUND OF THE INVENTION

The present invention generally relates to searching databases, and more particularly to a method of searching an electronic database using a primary search strategy and one or more sub-primary search strategies.

Electronic databases are increasingly utilized for a wide variety of applications. A large number of records are typically stored within these databases so that a user can search for specific information such as words or phrases using a computer. These databases are frequently searched by using logical expressions in which indicators (i.e. operators) are used to define relationships between words or character strings (i.e. operands). The indicators may include traditional as well as non-traditional Boolean indicators including but not limited to AND, OR, NOT, WITH and SAME. A search using indicators of this type searches records stored within the database and identifies those records satisfying the logical expression to the searcher as a search result.

For example, a user may wish to search an electronic legal database for case law dealing with an “experimental use exception.” In such a case, the user may enter “experimental AND use AND exception” as the logical expression. If this logical expression fails to produce any matching records, the user may be required to type in a new search string such as “experimental AND use.” This procedure continues until the user is satisfied with the search results returned from the electronic database.

Disadvantageously, searching in this manner is not efficient. A searcher must continuously modify the logical expression until a satisfactory search result is achieved. This may result in a loss of time, loss of profits and agitation to the searcher. Alternatively, the searcher may use the following logical expression to eliminate the need to modify the search logical expression: “(experimental AND use AND exception) OR (experimental AND use).” However, the search results returned by a logical expression of this type are not segregated into two search results that include one set of results having only “experimental AND use AND exception” records and another set of results having only “experimental AND use” records. In fact, the searcher cannot, without inspecting the identified records, determine if the search returned records that conform to the most preferred criteria or the less preferred criteria. Therefore, it may be difficult to immediately identify those records that are of the highest priority to the searcher.

Accordingly, it is desirable to provide a method for searching an electronic database that increases search efficiency and that automatically produces search results without the need for modifying the logical expression.

### SUMMARY OF THE INVENTION

An example method for searching a database comprises entering a logical expression including a dispensable portion, using the dispensable portion to distinguish between a primary search strategy and a secondary search strategy, and returning a search result that includes records satisfying at least one of the primary and secondary search strategies. In one example, the dispensability of at least a portion of the logical expression is identified by embracing a portion of the logical expression with a dispensability indicator.

A second search result that includes records satisfying the secondary search strategy is automatically rendered where a search for records satisfying the primary search strategy fails to render any results. In one example, the secondary search strategy comprises the primary search strategy excluding the portion of the logical expression embraced by dispensability indicator.

In yet another example, records satisfying both the primary search strategy and the secondary search strategy are returned when at least one record that satisfies the primary search strategy and at least one record that satisfies the secondary search strategy are included within the database being searched. The records returned from a search for the primary search strategy and records returned from the search for the secondary search strategy may also be segregated into a first preference grouping and a second preference grouping.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic representation of a search environment capable of utilizing a dispensability indicator according to the present invention; and

FIG. 2 is a block diagram representing a method of searching a database that utilizes the dispensability indicator of the present invention.

### DETAILED DESCRIPTION OF THE PREFERRED EMBODIMENT

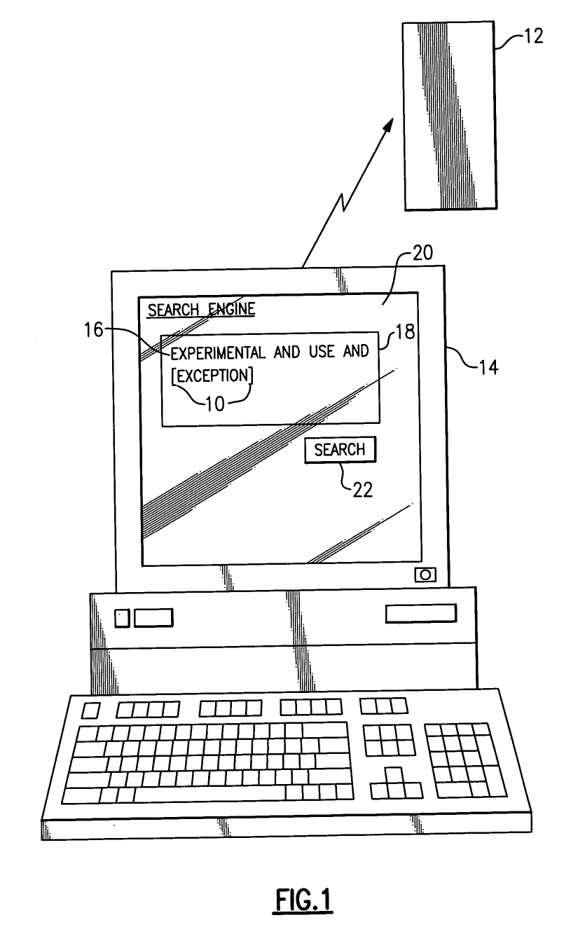

Referring to FIG. 1, a dispensability indicator 10 according to the present invention is illustrated. The dispensability indicator 10 is used to search a database 12 with a personal computer 14 or the like for preferred records, and at the same time, indicates that if preferred records are not found the searcher is willing to accept less preferred records. The dispensability indicator 10 may be incorporated into a search algorithm of any known logical or Boolean search engine 20 or any other search engine 20 known in the art. A worker of ordinary skill in the art with the benefit of the teachings herein will be able to implement the appropriate instructions into known search algorithms to facilitate the search of a database 12 for preferred information, as is further discussed in the paragraphs that follow.

In one example, the dispensability indicator 10 comprises a character symbol such as a pair of opposing brackets. A logical expression 16 is entered into a search box 18 of a search engine 20. A portion of the logical expression 16 is embraced by the dispensability indicator 10 to indicate the relative dispensability of each operand, operator, or word fragment of the logical expression 16. Although the dispensability indicator 10 is shown and described herein as a pair of opposing brackets, it should be understood that the dispensability indicator 10 of the present invention may take any other shape or form. Once the logical expression 16 is entered to the satisfaction of the searcher, a search button 22 is manipulated to initiate the search of the database 12 for matching records.

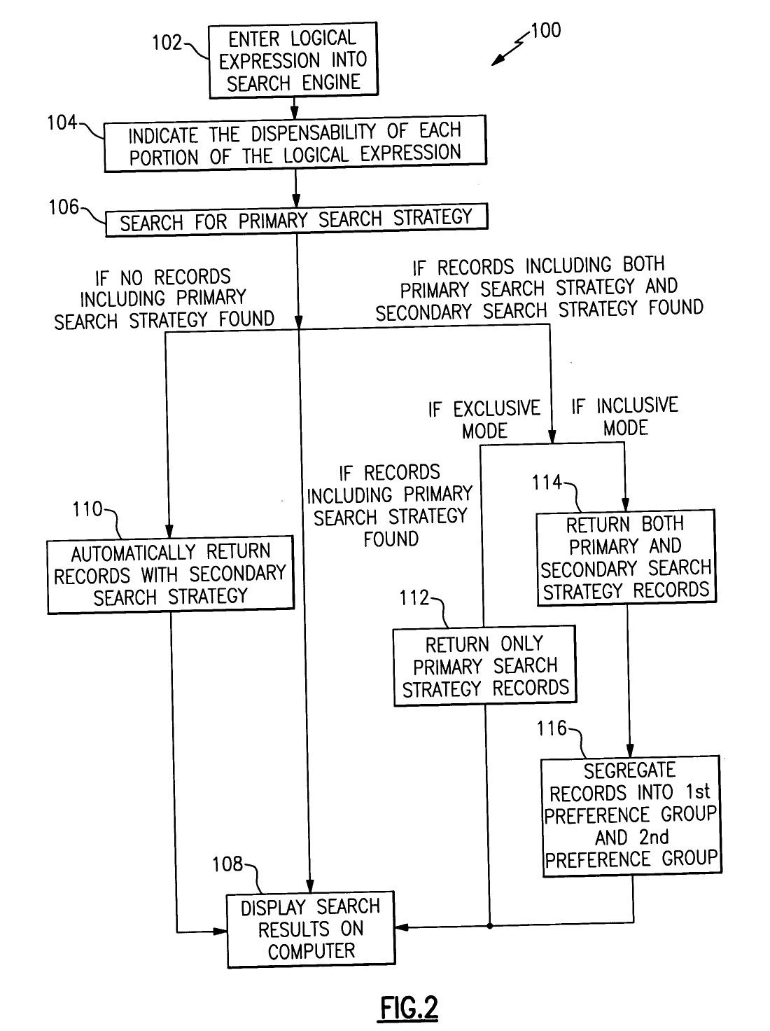

Referring to FIG. 2, and with continuing reference to FIG. 1, a method 100 for searching the database 12 utilizing the dispensability indicator 10 is described. The method 100 begins at step block 102 where a searcher enters the logical expression 16 into the search engine 20 on the personal computer 14. The logical expression 16 includes any combination of operands/character strings and operators/indicators that represent the criteria that the searcher wishes the search engine 20 to use to locate the desired records stored within the database 12. Next, at step block 104, the searcher indicates the dispensability of a portion of the logical expression 16. The dispensability of a portion of the logical expression 16 is indicated by embracing the desired portion of the logical expression 16 with one or more dispensability indicators 10. In one example, the dispensability of an operand of the logical expression 16 is indicated by embracing the operand within a pair of opposing brackets. The dispensability indicator 10 may be used to assign multiple levels of dispensability to any portion of the logical expression 16.

The dispensability indicator 10 instructs the search algorithm to give preference to records that contain the logical expression 16 including the portion of the logical expression 16 indicated by the dispensability indicator 10 (i.e. a primary search strategy) at step block 106. If records are found in the database that satisfy the primary search strategy, these records are revealed to the searcher on the personal computer 14 at step block 108. If the database 12 does not have any records that satisfy the primary search strategy, the search algorithm automatically identifies records that include a modified logical expression. The modified logical expression excludes the portion of the logical expression 16 that is indicated by the dispensability indicator 10 (i.e., a secondary search strategy) at step block 110. That is, the search algorithm intentionally ignores those operands embraced by the dispensability indicator 10 and searches for records that satisfy the secondary search strategy only. These records are then displayed on the personal computer 14 at step block 108.

The database 12 may contain at least one record that satisfies the primary search strategy and at least one record that satisfies the secondary search strategy. In such an instance, the search algorithm may be instructed to perform in one of two ways.

First, at step block 112, the search algorithm may operate in an exclusive mode in which only the records satisfying the primary search strategy are returned. That is, only those records containing the entire logical expression 16 as entered in step block 102 are revealed to the user on the personal computer 14.

Second, as shown in step block 114, the search algorithm may operate in an inclusive mode in which both preferred records and less preferred records are identified. That is, both records satisfying the primary search strategy and records satisfying the secondary search strategy are identified in the inclusive mode. The search algorithm may be coded by a programmer to operate in either the exclusive mode or the inclusive mode, or the mode in which the search algorithm operates may be programmed to be selectable by the searcher.

Where the search algorithm is operating in the inclusive mode, the search results are ideally segregated into preference groupings at step block 116. The search results are segregated into multiple preference groupings with a first preference grouping including the records satisfying the primary search strategy and a second preference grouping representing those records satisfying the secondary search strategy and so on. In one example, the first preference grouping and the second preference grouping are related to each other in a subset/superset relationship. It should be understood that the results returned by the database 12 may comprise a plurality of preference groupings depending upon the number of portions of each logical expression 16 that are identified by at least one dispensability indicator 10. These records are revealed to the user on the personal computer 14 at step block 108 whether the search algorithm is operating in the exclusive or inclusive mode.

In another example, a search in the inclusive mode may return records that include the first preference grouping and the second preference grouping as disjoint sets. For example, a search may return 30 records that satisfy the primary search strategy and 50 records that satisfy the secondary search strategy. However, 30 of the 50 records returned under the secondary search strategy are those returned by the primary search strategy. The search algorithm may therefore be programmed to return a second preference grouping containing only those 20 records that are unique to the secondary search strategy.

To illustrate the method 100 of the present invention, again suppose a searcher is searching a legal database for case law dealing with the “experimental use exception” with a search algorithm programmed to utilize the dispensability indicator 10. The searcher also prefers to identify records with the exact phrase “experimental use exception.” However, the searcher is willing to accept records containing the phrase “experimental use”. In such an example, utilizing the dispensability indicator 10, the searcher enters the following logical expression 16 into the search engine 20:
“experimental use [exception]”

The use of the dispensability indicator 10 (the pair of opposing brackets) to embrace the operand “exception” instructs the search algorithm to give a first preference to records containing the concatenated operands “experimental use exception.” That is, “experimental use exception” is the primary search strategy.

In an instance where the database searched by the searcher does not have any records that include the logical expression “experimental use exception”, the search algorithm will, without further intervention or need to modify the search by the searcher, automatically return records containing only the words “experimental use” (assuming such records exist). That is, “experimental use” is the secondary search strategy. The search algorithm disregards that portion of the logical expression 16 whose relative dispensability has been indicated by the dispensability indicator 10, i.e. the operand “exception”, and automatically returns records satisfying the secondary search strategy, i.e. “experimental use” where the search fails to produce records satisfying the primary search strategy.

The dispensability indicator 10 can be applied to any of the concatenated operands of a logical expression 16. In the interest of brevity, the following examples use “A”, “B” and “C” rather than “experimental use exception.” For example, a searcher who wishes to find records containing the logical expression “A B C” where A, B and C represent operands may enter the following search:
“[A] B C”

A logical expression of this type indicates a preference for records containing the operands “A B C”, but also indicates the willingness of the searcher to accept records containing only the operands “BC”.

In the alternative, the searcher may wish to find records containing the following logical expression:
“A [B] C”
   A logical expression of this type indicates a preference for records containing the operands “A B C”, but also indicates the willingness of the searcher to accept records containing only the operands “AC”.

The dispensability indicator 10 may also be nested to define a plurality of dispensable portions of a logical expression. For example, a searcher may enter the following logical expression into a search box of a search engine:
“[[A]] B [C]”
   This logical expression indicates a preference for records including the operands “A B C” while simultaneously indicating a second preference for records including the operands “BC” and a willingness to accept as a last preference records including the operand “B” only.

Nesting of the dispensability indicators 10 instructs the search algorithm to first dispense with the portion of the logical expression embraced by the greatest number of dispensability indicators 10 and subsequently dispense with that portion of the logical expression embraced by the second greatest number of dispensability indicators 10 and so on. Therefore, using the previous example, the search algorithm automatically dispenses with the operand “A” when no records are returned from a search for “A B C” as “A” is embraced by two pairs of opposing brackets and is therefore the most disposable operand. A search for records containing the logical expression “BC” is next performed. If records containing the logical expression “B C” therein are likewise not found, the search algorithm automatically dispenses with the operand “C” as “C” is embraced by one pair of opposing brackets and is considered the second most disposable operand behind the operand “A”. An immediate search for records including only the operand “B” is next commenced. As B is not embraced by a dispensability indicator 10, the search algorithm considers “B” as an indispensable operand.

In addition, the dispensability indicator 10 may be distributed. For instance, the searcher may attempt to search the following logical expression:
“[A] B [C]”
   A search with a logical expression of this type reveals that the searcher prefers to locate records containing the operands “A B C”, but is also willing to dispense with the operands “A” and “C” and accept those records containing only the operand “B”.

The dispensability indicator 10 may also be used on operands related by a Boolean or non-Boolean operator. For example, the searcher may enter the following logical expression having operands related by Boolean operators:
“[(A OR B)] AND (C AND D)”
   This example demonstrates that the searcher prefers to locate records containing either of operands “A” or “B” in combination with both of operands “C” and “D”, but will accept those records including only “C and D”.

The dispensability indicator 10 can also be applied to operators. For example, the searcher may enter the following logical expression:
“A [AND] OR B”
   This example demonstrates that the searcher prefers to locate records containing the operands “A” and “B”, but will accept those records containing “A” or “B”.

The dispensability indicator 10 may also be used with non-Boolean operators such as “SAME” (which indicates that the operands must be in the same paragraph) and “WITH” (which indicates that the operands must be in the same sentence). For example, a search for “A SAME [WITH] B” indicates that the searcher prefers to locate records with operands “A” and “B” in the same sentence (WITH) but will accept records with operands “A” and “B” in the same paragraph (SAME). In other words, the dispensability indicator 10 is applied to the operator corresponding to the most restrictive search criterion.

The dispensability indicator 10 may also be applied to more than one operator. For example, a search for “A [[ADJ2]] [WITH] SAME B” indicates a first preference for records having the operands “A” and “B” within 2 words of each other and in the order specified (ADJ2), a second preference for records having the operands “A” and “B” in the same sentence (WITH), and a last preference for records having the operands “A” and “B” in the same paragraph.

The previous example serves to illustrate the dual function of the dispensability indicator 10. First, the dispensability indicator 10 instructs the search algorithm that the “ADJ2” indicator should be used as part of the primary search strategy. Second, where records that satisfy the primary search strategy are not found, the nested dispensability indicators 10 indicate to the search algorithm that the indicator “ADJ2” should be disposed of first and that the search should continue with a secondary search strategy that includes the indicator “WITH”. Finally, if the secondary search strategy fails to identify any records, the nested dispensability indicators 10 indicate to the search algorithm that the indicator “WITH” should next be disposed of and that the search should continue with a third search strategy that includes the indicator “SAME”.

In yet another example, the dispensability indicator 10 is applied to word fragments. A searcher may search for records including the following fragmented logical expression:
“patent(able[ability])”
   A search of this type informs the search algorithm that the searcher prefers to locate records having the word “patentability”, but will also accept as a second preference those records containing the word “patentable.” It should be understood that use of the parentheses in the previous example is solely done to enclose that portion of the logical expression 16 that is subject to the dispensability condition and are not interpreted by the search algorithm as operands to be searched for.

In another example, the dispensability indicator 10 is used in combination with a global or universal character. A global or universal character is often used as a substitute for one or several individual characters to produce search results that include a root character string with any number of substituted characters. A search of the logical expression “patent([able])” indicates that the searcher prefers to find records having the word “patentable” therein, but will accept any record containing the root characters “patent”.

The present invention provides a dispensability indicator 10 in which a database 12 may be searched for multiple logical expressions 16 without the need to physically modify the logical expression 16. The inventive concept has been described in terms of a pair of opposing brackets wherein operands or operators of the logical expression 16 embraced by a single set of opposing brackets are considered more dispensable than operands or operators of the logical expression 16 that are not embraced by opposing brackets, and operands or operators of the logical expression 16 embraced by a double set of opposing brackets are considered more dispensable than those operands or operators of the logical expression 16 embraced by a single set of opposing brackets and so on. If the search of the primary search strategy fails to render any satisfactory results, the search algorithm automatically disregards the operands or operators embraced by the largest number of opposing brackets and returns records satisfying the secondary search strategy. The secondary search strategy excludes the portion of the primary search strategy indicated by the greatest number of opposing brackets.

Although the present invention has been presented in terms of a dispensability indicator 10, it should be understood that a search algorithm could be programmed to recognize the opposing brackets as a nondispensability indicator in which the portions of the logical expression surrounded by brackets are considered less dispensable than those portions not surrounded by brackets. For example, a search of the logical expression “[A] B C” indicates a preference for records containing the operands “ABC” but also indicates a willingness to accept records containing the operand “A.”

The foregoing description shall be interpreted as illustrative and not in a limiting sense. A worker of ordinary skill in the art would recognize that certain modification would come within the scope of this invention. For that reason, the following claims should be studied to determine the true scope and content of this invention.

What is claimed is:

1. A method for searching a database, comprising the steps of:
(a) entering a logical expression including a dispensable portion;
(b) using the dispensable portion to distinguish between at least a primary search strategy and a secondary search strategy; and
(c) returning a search result that includes records that satisfy requirements of at least one of the primary search strategy and the secondary search strategy.

2. The method as recited in claim 1, wherein said step (b) further comprises:
identifying the dispensability of at least a portion of the logical expression by embracing the at least a portion of the logical expression with a dispensability indicator.

3. The method as recited in claim 2, wherein the secondary search strategy comprises the primary search strategy excluding the at least a portion of the logical expression identified by the dispensability indicator.

4. The method as recited in claim 2, wherein the dispensability indicator comprises a character symbol.

5. The method as recited in claim 3, wherein said step (c) includes:
automatically returning the search result with records that satisfy requirements of the secondary search strategy in response to a failure to return records satisfying the primary search strategy.

6. The method as recited in claim 1, wherein said step (c) includes:
simultaneously returning records that satisfy requirements of the primary search strategy and the secondary search strategy in response to the database including at least one record satisfying requirements of the primary search strategy and at least one record satisfying requirements of the secondary search strategy.

7. The method as recited in claim 6, wherein said step (c) includes:
segregating the records into a first preference grouping including records satisfying requirements of the primary search strategy and a second preference grouping including records satisfying requirements of the secondary search strategy.

8. The method as recited in claim 1, wherein the dispensable portion comprises at least one operand.

9. The method as recited in claim 1, wherein the dispensable portion comprises at least one operator.

10. A method of searching a database, comprising the steps of:
(a) entering a logical expression including identifying a portion of the logical expression with at least one dispensability indicator to define a primary search strategy;
(b) searching the database for records satisfying requirements of the primary search strategy; and
(c) returning a first set of records that satisfy the primary search strategy.

11. The method as recited in claim 10, wherein the logical expression corresponding to the primary search strategy includes the portion of the logical expression identified by the at least one dispensability indicator.

12. The method as recited in claim 10, further comprising the step of:
(d) automatically returning a second set of records that satisfy a secondary search strategy in response to the database failing to return the first set of records in said step (c).

13. The method as recited in claim 12, wherein the logical expression corresponding to the secondary search strategy excludes the portion of the logical expression identified by the at least one dispensability indicator.

14. The method as recited in claim 12, wherein the logical expression corresponding to the secondary search strategy includes the portion of the logical expression identified by the at least one dispensability indicator.

15. The method as recited in claim 12, further comprising the step of:
(e) simultaneously returning the first set of records and the second set of records, wherein the first set of records is segregated from the second set of records.

16. The method as recited in claim 10, wherein the at least one dispensability indicator comprises a plurality of dispensability indicators and wherein said step (a) further comprises:
nesting the plurality of dispensability indicators within the logical expression to define a plurality of dispensable portions, wherein a portion of the logical expression embraced by the greatest number of dispensability indicators comprises the portion of the logical expression that is first dispensed; and
dispensing a first one of the plurality of dispensable portions which is embraced by the greatest number of dispensability indicators.

17. The method as recited in claim 16, wherein the plurality of dispensable portions comprise at least one operand.

18. The method as recited in claim 16, wherein the plurality of dispensable portions comprise at least one operator.

19. The method as recited in claim 10, wherein the logical expression includes at least one of an operand, indicator and a character string.

20. The method as recited in claim 10, wherein the dispensability indicator comprises a character symbol.
